(19) United States
(12) Patent Application Publication
(10) Pub. No.: US 2009/0145392 A1
(43) Pub. Date: Jun. 11, 2009

(54) FUEL FORMULATIONS

(76) Inventors: Richard Hugh CLARK, Cheshire (GB); Gregory Matthew Leach, Chester (GB); Beverley Van Sluis, Cheshire (GB); Robert Wilfred Matthews Wardle, Cheshire (GB)

Correspondence Address: SHELL OIL COMPANY, P O BOX 2463, HOUSTON, TX, 772522463, US

(21) Appl. No.: 12/323,277

(22) Filed: Nov. 25, 2008

(30) Foreign Application Priority Data
Nov. 30, 2007 (EP) 07122029.7

(51) Int. Cl. F02M 25/00; C10L 1/32; F02M 25/022; F01N 3/00

(52) U.S. Cl. 123/1 A; 44/301; 60/274

(57) ABSTRACT

A diesel fuel formulation is disclosed containing a water-in-fuel emulsion of (a) a Fischer-Tropsch derived gas oil, optionally in combination with conventional diesel, (b) a fatty acid alkyl ester in an amount of at least 1% v/v and (c) water. An emulsifier may be present.

Formulations have useful emissions properties and retain performance characteristics in spite of the presence of water.

Methods of preparing the formulations and their uses are also described.

This application claims the benefit of European Application No. 07122029.7 filed Nov. 30, 2007.

### FIELD OF THE INVENTION

The present invention relates to diesel fuel formulations and their preparation and use, as well as pre-mixes used to form these, as well as vehicle emission control systems which utilise them.

### BACKGROUND OF THE INVENTION

Emulsions of water can be formed in hydrocarbon fuels. In the case of diesel fuels such as automotive gas oils, such emulsions have been shown to reduce levels of emissions on combustion, in particular reducing nitrogen oxide (NOx) and particulate matter (PM) emissions (see for example Y. Yoshimito et al. SAE Paper 982490, (1998); Barnaud et al. SAE Paper 2000-01-1861 (2000) and WO-A-99/13028.

Diesel fuel formulations can include the reaction products of Fischer-Tropsch condensation processes, for example, such as the process known as Shell Middle Distillate Synthesis (van der Burgt et al, “The Shell Middle Distillate Synthesis Process”, paper delivered at the 5th Synfuels Worldwide Symposium, Washington D.C., November 1985; see also the November 1989 publication of the same title from Shell International Petroleum Company Ltd, London, UK). In particular, automotive diesel fuel compositions can include Fischer-Tropsch derived gas oils often in blends with other diesel base fuels such as petroleum derived gas oils.

The benefits of Fischer-Tropsch derived fuels, as compared to their petroleum derived counterparts, include their relatively high cetane numbers, their relatively low emissions on combustion, for example in an engine, and their typically low levels of undesirable fuel components such as sulphur, nitrogen and aromatics.

When an emulsion is formed between water and a Fischer-Tropsch derived fuel, again improvements in emissions levels have been found to result, as shown in U.S. Pat. No. 7,229,481. Here it was also found that Fischer-Tropsch fuels, having typically higher cetane numbers than conventional petroleum derived fuels, can help to compensate for the cetane number lowering effect of the water. This in turn can help to reduce problems such as impaired engine performance and noise, which are potentially associated with reduced cetane number. It can also allow the use of lower levels of ignition improving additives in the water/fuel mixtures.

Biofuels such as rapeseed methyl ester (RME) and other fatty acid alkyl esters (FAAEs) have been included in diesel fuel blends in order to reduce life cycle greenhouse gas emissions and restore lubricity, in particular to fuels which have been subjected to high levels of hydrotreatment to reduce sulphur levels. There may be environmental reasons why the use of biofuels is particularly preferred in some instances. They are, however, known to increase the density of the blend with respect to the base fuel and can increase tailpipe nitrogen oxide (NOx) emissions.

WO-A-2004/035713 describes the use of these and other oxygenates in ternary fuel blends which mimic the properties of the base fuel, and give overall improved performance.

However, oxygenates of this type are generally polar in nature. As a result, they would be expected to alter the polarity of the diesel phase of a diesel-water system, thus making emulsions of the type described in U.S. Pat. No. 7,229,481 difficult to make and unstable once formed.

### SUMMARY OF THE INVENTION

A diesel fuel formulation is provided comprising a water-in-fuel emulsion of (a) a Fischer-Tropsch derived gas oil, (b) a fatty acid alkyl ester in an amount of at least 1% v/v and (c) water. A method for preparing such formulation, and a kit for preparing such formulation is also provided. A method of operating a fuel consuming system is also provided.

### DETAILED DESCRIPTION OF THE INVENTION

The applicants have found, that in so far as even relatively high levels of oxygenates may be included and thus be useful fuel components, without reducing stability to an impractical extent.

According to one embodiment of the present invention there is provided a diesel fuel formulation containing a water-in-fuel emulsion of (a) a Fischer-Tropsch derived gas oil, (b) a fatty acid alkyl ester in an amount of at least 1% v/v and (c) water.

In a particular embodiment, the formulation further contains an emulsifier.

The applicants have found that emulsions comprising 1% v/v or more of fatty acid alkyl ester may be formed without difficulty. Furthermore, they have been found to be stable for significant periods of time, thus allowing them to be used in practical situations. As a result, formulations with significant advantages may be formed.

In particular, the formulations have good performance, and may remain on specification in spite of the presence of water in relatively high amounts, as a result of the inclusion of Fischer-Tropsch derived gas oils, and also fatty acid alkyl esters to some extent. These have a high cetane number, which therefore counteracts any reduction in cetane number produced as a result of the addition of water. (Water in diesel is known to lower the cetane number potentially giving problematic combustion performance and noise.)

Furthermore, the formulations may give rise to reduced nitrogen oxide (NOx) or particulate matter (PM) emissions in some circumstances. This is because any increase in NOx emissions as a result of the presence of fatty acid alkyl esters is countered by the presence of Fischer-Tropsch derived gas oil and water in the formulation. Furthermore, the fatty acid alkyl esters themselves will produce less PM emissions and black smoke.

In addition, the inclusion of water means that the formulations are cost effective to produce.

In a formulation according to the present invention, the concentration of the fatty acid alkyl ester (b) may be 1% v/v or greater, for example 1.2% v/v or greater or 1.5% v/v or greater, for instance 2% v/v or greater or even 3% v/v or greater or 5% v/v or greater or 7% v/v or greater. It may be up to 30% v/v, for example up to 20% v/v or preferably up to 10% v/v. A suitable concentration may be from 1 to 30% v/v, such as from 1.2 to 20% v/v or from 5 to 10% v/v.

In a formulation according to the present invention, the concentration of water may be 1% v/v or greater, for example 5% v/v or greater, such as 10% v/v or greater. It may be up to 35% v/v, for example up to 30% v/v or 25% v/v. A suitable concentration may be from 1 to 35% v/v or from 1 to 30% v/v, for instance from 5 to 25% v/v.

Where an emulsifier is present, its concentration in the formulation may be 0.1% v/v or greater, for example 0.5% v/v or greater. It may be up to 10% v/v, for example up to 5% v/v. A suitable concentration may be from 0.1 to 10% v/v or from 0.5 to 5% v/v.

In some embodiments, the Fischer-Tropsch derived gas oil will constitute the balance or substantial balance of the formulation, depending upon whether other additives, for example as described below, are present in the formulation. However, in a particular embodiment, the formulation will contain conventional, petroleum derived, diesel as well as the Fischer-Tropsch derived gas oil, and these two components together will make up the balance of the formulation.

Typically in a formulation according to the present invention, the concentration of the Fischer-Tropsch derived gas oil (a) may be 0.5% v/v or greater. It may be up to 98% v/v, for example up to 90% v/v such as up to 85% v/v. A suitable concentration may be from 0.5% to 99% v/v or from 0.5% to 90% v/v, for example from 0.5% to 85% v/v.

Where present, conventional diesel is suitably present in a formulation according to the present invention, at a concentration of 0.5% v/v or greater. It may be up to 85% v/v, for example up to 75% v/v. A suitable concentration may be from 0.5% v/v to 85% v/v or from 0.5% v/v to 75% v/v, for instance from 0.5% v/v to 50% v/v.

The water-in-fuel emulsion may be prepared using conventional emulsion preparation techniques, typically by blending together, with agitation, the components (a), (b) and (c), and optionally also conventional diesel, suitably with an emulsifier. In particular, components (a) and (b) are mixed together with any conventional diesel fuel and emulsifier used with rapid stirring using a device such as a high shear mixer, for instance a Silverson high shear laboratory mixer. Component (c), water, is then added gradually, at a rate suitable to give rise to an emulsion bearing in mind the speed of stirring, etc. For example, the water may be added dropwise, whilst stirring is carried out. Stirring is continued after completion of the addition, for example for a period of 1 to 5 minutes to ensure that mixing is complete. The procedure is conveniently carried out at room temperature, pressure and humidity.

Processes of this type form another aspect of the present invention.

Diesel emulsions of the type which form the subject of the present invention are generally blended and then used as an automotive fuel immediately or within a few days, for example up to 5 days, and preferably up to 2 days, of preparation. In order to achieve this, the components or pre-mixes of one or more of the components are delivered to a site, such as a transport distribution or public transport depot, and mixed using a suitable stirring device on site, ready for use.

As such, a kit comprising a combination of at least two members selected from the group consisting of (i) component (a) above, (ii) component (b) above and (iii) an emulsifier forms a third aspect of the present invention. Suitably the kit comprises all three of (i), (ii) and (iii). It may optionally further comprise conventional diesel if required in the formulation. Water, in particular deionised water suitable as component (c), may also be supplied with the kit if required, although this may be sourced separately. The relative amounts of the components of the kit are selected so that they may form a formulation of the present invention as described above. The kit may be accompanied by a set of instructions to allow the components to be mixed together and formed into an emulsion. Apparatus suitable for forming the emulsion, in particular a high shear mixer, may also be supplied and thus a combination of such an apparatus and a kit as described above may form a fourth aspect of the present invention.

If required, pre-mixes comprising two or more components (i), (ii) or (iii), as well as any conventional diesel required for formation of a formulation of the present invention, may suitably be provided, for example as an element of a kit as described above.

Thus, another aspect of the present invention provides a diesel fuel formulation pre-mix which comprises at least two of (a) a Fischer-Tropsch derived gas oil and (b) a fatty acid alkyl ester in an amount so that it comprises at least 1% v/v in a diesel fuel formulation prepared therefrom, and an emulsifier. The pre-mix may further contain conventional diesel where this is required in the final formulation. Emulsifiers are suitably present in an amount such that they comprise from 0.1 to 10% v/v of the final formulation, once the water has been added.

By “Fischer-Tropsch derived” is meant that a fuel is, or derives from, a synthesis product of a Fischer-Tropsch condensation process. A Fischer-Tropsch derived fuel may also be referred to as a GTL (Gas-to-Liquid) fuel. The term “non-Fischer-Tropsch derived” may be construed accordingly.

Fischer-Tropsch derived fuels are known and in use in for instance automotive diesel fuel compositions, and are described in more detail below. They tend to contain low levels of aromatic fuel components and of sulphur and other polar species, and to have relatively high cetane numbers when compared to their mineral derived counterparts.

The Fischer-Tropsch reaction converts carbon monoxide and hydrogen into longer chain, usually paraffinic, hydrocarbons:

n(CO+2H₂)═(—CH₂—)ₙ+nH₂O+heat,

in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane. The gases which are converted into liquid fuel components using such processes can in general include natural gas (methane), LPG (e.g. propane or butane), “condensates” such as ethane, synthesis gas (CO/hydrogen) and gaseous products derived from coal, biomass and other hydrocarbons.

Gas oil products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range (see, e.g. GB-B-2077289 and EP-A-0147873) and/or hydroisomerisation which can improve cold flow properties by increasing the proportion of branched paraffins. EP-A-0583836 describes a two step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel. The desired gas oil fraction(s) may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for instance in U.S. Pat. No. 4,125,566 and U.S. Pat. No. 4,478,955.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP-A-0583836 (pages 3 and 4).

An example of a Fischer-Tropsch based process is the SMDS (Shell Middle Distillate Synthesis) described by van der Burgt et al in “The Shell Middle Distillate Synthesis Process”, paper delivered at the 5th Synfuels Worldwide Symposium, Washington D.C., November 1985 (see also the November 1989 publication of the same title from Shell International Petroleum Company Ltd, London, UK). This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as the gas oils useable in diesel fuel compositions. A version of the SMDS process, utilising a fixed bed reactor for the catalytic conversion step, is currently in use in Bintulu, Malaysia and its gas oil products have been blended with petroleum derived gas oils in commercially available automotive fuels.

Gas oils prepared by the SMDS process are commercially available for instance from Shell companies. Further examples of Fischer-Tropsch derived gas oils are described in EP-A-0583836, EP-A-1101813, WO-A-97/14768, WO-A-97/14769, WO-A-00/20534, WO-A-00/20535, WO-A-00/11116, WO-A-00/11117, WO-A-01/83406, WO-A-01/83641, WO-A-01/83647, WO-A-01/83648 and U.S. Pat. No. 6,204,426.

By virtue of the Fischer-Tropsch process, a Fischer-Tropsch derived fuel has essentially no, or undetectable levels of, sulphur and nitrogen. Compounds containing these heteroatoms tend to act as poisons for Fischer-Tropsch catalysts and are therefore removed from the synthesis gas feed. Fischer-Tropsch derived fuels are known to give rise to reduced levels of emissions (in particular NOx and particulate matter emissions) compared to their petroleum derived counterparts.

Further, the Fischer-Tropsch process as usually operated produces no or virtually no aromatic components. The aromatics content of a Fischer-Tropsch derived fuel, suitably determined by ASTM D4629, will typically be below 1% w/w, preferably below 0.5% w/w and more preferably below 0.2 or 0.1% w/w.

Generally speaking, Fischer-Tropsch derived fuels have relatively low levels of polar components, in particular polar surfactants, for instance compared to petroleum derived fuels. Such polar components may include for example oxygenates, and sulphur- and nitrogen-containing compounds. A low level of sulphur in a Fischer-Tropsch derived fuel is generally indicative of low levels of both oxygenates and nitrogen-containing compounds, since all are removed by the same treatment processes.

A Fischer-Tropsch derived gas oil should be suitable for use as a diesel fuel, ideally as an automotive diesel fuel; its components (or the majority, for instance 95% v/v or greater, thereof) should therefore have boiling points within the typical diesel fuel (“gas oil”) range, i.e. from about 150 to 400° C. or from 170 to 370° C. It will suitably have a 90% v/v distillation temperature of from 300 to 370° C.

A Fischer-Tropsch derived gas oil will typically have a density from 0.76 to 0.79 g/cm³ at 15° C.; a cetane number (ASTM D613) greater than 70, suitably from 74 to 85; a kinematic viscosity (ASTM D445) from 2 to 4.5, preferably from 2.5 to 4.0, more preferably from 2.9 to 3.7, mm²/s at 40° C.; and a sulphur content (ASTM D2622) of 5 mg/kg or less, preferably of 2 mg/kg or less.

Preferably a Fischer-Tropsch derived gas oil used in the present invention is a product prepared by a Fischer-Tropsch methane condensation reaction using a hydrogen/carbon monoxide ratio of less than 2.5, preferably less than 1.75, more preferably from 0.4 to 1.5, and ideally using a cobalt containing catalyst. Suitably it will have been obtained from a hydrocracked Fischer-Tropsch synthesis product (for instance as described in GB-B-2077289 and/or EP-A-0147873), or more preferably a product from a two-stage hydroconversion process such as that described in EP-A-0583836 (see above). In the latter case, preferred features of the hydroconversion process may be as disclosed at pages 4 to 6, and in the examples, of EP-A-0583836.

Suitably a Fischer-Tropsch derived gas oil used in the present invention is a product prepared by a low temperature Fischer-Tropsch process, by which is meant a process operated at a temperature of 250° C. or lower, such as from 125 to 250° C. or from 175 to 250° C., as opposed to a high temperature Fischer-Tropsch process which might typically be operated at a temperature of from 300 to 350° C.

Suitably, in accordance with the present invention, a Fischer-Tropsch derived gas oil will consist of at least 70% w/w, preferably at least 80% w/w, more preferably at least 90 or 95 or 98% w/w, most preferably at least 99 or 99.5 or even 99.8% w/w, of paraffinic components, preferably iso- and normal paraffins. The weight ratio of iso-paraffins to normal paraffins will suitably be greater than 0.3 and may be up to 12; suitably it is from 2 to 6. The actual value for this ratio will be determined, in part, by the hydroconversion process used to prepare the gas oil from the Fischer-Tropsch synthesis product.

The olefin content of the Fischer-Tropsch derived gas oil is suitably 0.5% w/w or lower. Its aromatics content is suitably 0.5% w/w or lower.

According to the present invention, a mixture of two or more Fischer-Tropsch derived gas oils may be used in the fuel formulation.

Suitably, the fatty acid alkyl ester is derived from organic material, as in the case of currently available “biofuels” such as vegetable oils and their derivatives—the use of such components in fuel formulations is becoming increasingly desirable, due to both environmental and associated legislative constraints, and can bring its own advantages. Biofuels such as rapeseed methyl ester (RME) have for example been included in diesel fuel blends in order to reduce life cycle greenhouse gas emissions and restore lubricity in particular to fuels which have been subjected to high levels of hydrotreatment to reduce sulphur levels.

Fatty acid alkyl esters (b), of which the most commonly used in the present context are the methyl esters, are already known as renewable diesel fuels (so-called “biodiesel” fuels). They contain long chain carboxylic groups (generally from 10 to 22 carbon atoms long), each having an alcohol-derived alkyl group attached to one end. Organically derived oils such as vegetable oils (including recycled vegetable oils) and animal fats can be subjected to a transesterification process with an alcohol (typically a C₁ to C₅ alcohol) to form the corresponding fatty esters, typically mono-alkylated. This process, which is suitably either acid- or base-catalysed such as with the base KOH, converts the triglycerides contained in the oils into fatty acid esters and free glycerol, by separating the fatty acid components of the oils from their glycerol backbone.

In accordance with the present invention, a fatty acid alkyl ester may be derived from any alkylated fatty acid or mixture of fatty acids. Its fatty acid component(s) are preferably derived from a biological source, more preferably a vegetable source. They may be saturated or unsaturated; if the latter, they may have one or more double bonds. They may be branched or un-branched. Suitably, they will have from 10 to 30, more suitably from 10 to 22 or from 12 to 22, carbon atoms in addition to the acid group(s) —CO₂H. A fatty acid alkyl ester will typically comprise a mixture of different fatty acid esters of different chain lengths, depending on its source. For instance the commonly available rapeseed oil contains mixtures of palmitic acid (C₁₆), stearic acid (C₁₈), oleic, linoleic and linolenic acids (C₁₈, with one, two and three unsaturated carbon-carbon bonds respectively) and sometimes also erucic acid (C₂₂)—of these the oleic and linoleic acids form the major proportion. Soybean oil contains a mixture of palmitic, stearic, oleic, linoleic and linolenic acids. Palm oil usually contains a mixture of palmitic, stearic and linoleic acid components.

A fatty acid alkyl ester used in the present invention is preferably derived from a natural fatty oil, for instance a vegetable oil such as rapeseed oil, soybean oil, coconut oil, sunflower oil, palm oil, peanut oil, linseed oil, camelina oil, safflower oil, babassu oil, tallow oil or rice bran oil. It may in particular be an alkyl ester (suitably the methyl ester) of rapeseed, soy, coconut or palm oil.

Such a fatty acid alkyl ester is preferably a C₁ to C₅ alkyl ester, more preferably a methyl, ethyl or propyl (suitably iso-propyl) ester, yet more preferably a methyl or ethyl ester and in particular a methyl ester.

A fatty acid alkyl ester may for example be selected from the group consisting of rapeseed methyl ester (RME, also known as rape oil methyl ester or rape methyl ester), soy methyl ester (SME, also known as soybean methyl ester), palm oil methyl ester (POME), coconut methyl ester (CME) (in particular unrefined CME; the refined product is based on the crude but with some of the higher and lower alkyl chains (typically the C₆, C₈, C₁₀, C₁₆ and C₁₈) components removed) and mixtures thereof. In general, it may be either natural or synthetic, refined or unrefined (“crude”).

The fatty acid alkyl ester (b) will typically be a liquid at ambient temperature, with a boiling point preferably from 100 to 360° C., more preferably from 250 to 290° C. Its density is suitably from 0.75 to 0.9 g/cm³ at 15° C. (ASTM D4502/IP 365), and its flash point greater than 55° C.

A fuel formulation according to the invention may contain a mixture of two or more fatty acid alkyl esters, for instance selected from those described above.

Suitable emulsifiers for use in the formulation of the present invention include surfactants. They may be ionic or non-ionic surfactants, in particular non-ionic surfactants. Suitable non-ionic surfactants include alkoxylates such as alcohol ethoxylates and alkylphenol ethoxylates; carboxylic acid esters, such as glycerol esters and polyoxyethylene esters; anhydrosorbitol esters, such as ethoxylated anhydrosorbitol esters; natural ethoxylated fats, oils and waxes; glycol esters of fatty acids; alkyl polyglycosides; carboxylic amides, such as diethanolamine condensates and monoalkanolamine condensates; fatty acid glucamides; polyalkylene oxide block copolymers and poly(oxyethylene-co-oxypropylene) non-ionic surfactants.

In a particular embodiment, a mixture of surfactants is used. It is preferred that the HLB (hydrophile-lipophile balance) value of the surfactant or mixture of surfactants is in the range 3 to 9, more preferably 3 to 6. In the case of a mixture of surfactants, the HLB of the mixture is dependent on the proportions of the surfactants in the mixture and their respective HLB values, and is preferably in the ranges given above.

Particularly suitable non-ionic surfactants include SPAN 85 (sorbitan trioleate, ex. Uniqema, HLB 1.8), SPAN 65 (sorbitan tristearate, ex. Uniqema, HLB 2.1), KESSCO PGMS PURE (propylene glycol monostearate, ex. Stepan, HLB 3.4), KESSCO GMS 63F (glycerol monostearate, ex. Stepan, HLB 3.8), SPAN 80 (sorbitan monooleate, ex. Uniqema, HLB 4.3), SPAN 60 (sorbitan monostearate, ex. Uniqema, HLB 4.7), BRIJ 52 (polyoxyethylene (2) cetyl ether, ex. Uniqema, HLB 5.3) and SPAN 20 (sorbitan monolaurate, ex. Uniqema, HLB 8.6). Further suitable non-ionic surfactants, which may be used in suitable proportions in mixtures having the preferred HLB values, include ALDO MSA (glycerol monostearate, ex. Lonza, HLB 11), RENEX 36 (polyoxyethylene (6) tridecyl ether, ex. Uniqema, HLB 11.4), BRIJ 56 (polyoxyethylene (10) cetyl ether, ex. Uniqema, HLB 12.9), TWEEN 21 (polyoxyethylene (4) sorbitan monolaurate, ex. Uniqema, HLB 13.3), RENEX 30 (polyoxyethylene (12) tridecyl ether, ex. Uniqema, HLB 14.5) and BRIJ 58 (polyoxyethylene (20) cetyl ether, ex. Uniqema, HLB 15.7).

A particularly suitable mixture comprises TWEEN 21 and SPAN 80 but mixtures may comprise any of the surfactants listed above.

Where present in the formulation of the present invention, the “conventional diesel” will comprise a diesel base fuel such as an automotive gas oil (AGO). Typical diesel fuel components comprise liquid hydrocarbon middle distillate fuel oils, for instance petroleum derived gas oils. Such base fuel components may be organically or synthetically derived. They will typically have boiling points within the usual diesel range of 125 or 150 to 400 or 550° C., depending on grade and use. They will typically have densities from 0.75 to 1.0 g/cm³, preferably from 0.8 to 0.9 or 0.86 g/cm³, at 15° C. (IP 365) and measured cetane numbers (ASTM D613) of from 35 to 80, more preferably from 40 to 75 or 70. Their initial boiling points will suitably be in the range 150 to 230° C. and their final boiling points in the range 290 to 400° C. Their kinematic viscosity at 40° C. (ASTM D445) might suitably be from 1.5 to 4.5 mm²/s.

Such fuels are generally suitable for use in a compression ignition (diesel) internal combustion engine, of either the indirect or direct injection type.

A fuel formulation according to the present invention may be suitable for use in a compression ignition (diesel) internal combustion engine, of either the indirect or direct injection type.

Such a diesel fuel formulation will suitably comply with applicable current standard specification(s) such as for example EN 590:2004 (for Europe) or ASTM D-975-06 (for the USA). By way of example, the formulation may have a density (EN ISO 12185) from 0.82 to 0.845 g/cm³ at 15° C.; a 95% recovered temperature (EN ISO 3405) of 360° C. or less; a cetane number (EN ISO 5165) of 51 or greater; a kinematic viscosity (EN ISO 3104) from 2 to 4.5 centistokes at 40° C.; a sulphur content (EN ISO 20847) of 50 ppmw or less; and/or a polyaromatics content (EN 12916) of less than 11%. Relevant specifications may, however, differ from country to country and from year to year and may depend on the intended use of the fuel composition.

A formulation according to the present invention is suitably stable for at least 12 hours following its preparation. It may be stable for at least 24 or 36 or 48 or 60 hours following its preparation. By “stable” is meant that, when the formulation is left to stand undisturbed, the organic and aqueous phases of the water-in-fuel emulsion do not visibly separate.

A fuel formulation according to the present invention may contain other components in addition to the Fischer-Tropsch derived gas oil, the fatty acid alkyl ester and the water. It may in particular include one or more diesel fuel additives. Many such additives are known and readily available.

The total additive content in the fuel formulation may suitably be from 50 to 10000 mg/kg, preferably below 5000 mg/kg.

Further additives which are often included in diesel fuel formulations are cetane improvers (also known as an ignition improvers). As a result of carrying out the present invention, however, lower levels of such additives may be needed as the presence of the Fischer-Tropsch derived gas oil can itself serve to increase the cetane number of the overall formulation, even in the presence of the normally cetane-lowering water. The oxygenate may also contribute to maintaining the cetane number.

Thus, according to another aspect of the present invention, there is provided a combination of a Fischer-Tropsch derived gas oil and a fatty acid alkyl ester in an emulsified diesel fuel formulation, that reduces the concentration of an additive selected from an ignition improving additive or lubricity enhancing additive in the formulation.

The ignition improving additive may be any suitable ignition improver. Many such additives are known and commercially available, and may also be known (in the context of diesel fuels) as “cetane improvers” or “cetane number improvers”; they typically function by increasing the concentration of free radicals in a fuel formulation. The ignition improver may in particular be a diesel fuel ignition improver, i.e. an ignition improving agent suitable for use in a diesel fuel formulation.

An ignition improver may for example be selected from:

a) organic nitrates of the general formula R¹—O—NO₂, or nitrites of the general formula R¹—O—NO, where R¹ is a hydrocarbyl group such as in particular an alkyl, cycloalkyl, alkenyl or aromatic group, or an ether containing group, preferably having from 1 to 10, more preferably from 1 to 8 or from 1 to 6 or from 1 to 4, carbon atoms;

b) organic peroxides and hydroperoxides, of the general formula R²—O—O—R³, where R² and R³ are each independently either hydrogen or a hydrocarbyl group such as in particular an alkyl, cycloalkyl, alkenyl or aromatic group, preferably having from 1 to 10, more preferably from 1 to 8 or from 1 to 6 or from 1 to 4, carbon atoms (provided that R² and R³ are not both hydrogen); and

c) organic peracids and peresters, of the general formula R⁴—C(O)—O—O—R⁵, where R⁴ and R⁵ are each independently either hydrogen or a hydrocarbyl group such as in particular an alkyl, cycloalkyl, alkenyl or aromatic group, preferably having from 1 to 10, more preferably from 1 to 8 or from 1 to 6, such as from 1 to 4, carbon atoms.

Examples of ignition improvers of type (a) include (cyclo)alkyl nitrates such as isopropyl nitrate, 2-ethylhexyl nitrate (2-EHN) and cyclohexyl nitrate, and ethyl nitrates such as methoxyethyl nitrate. Examples of type (b) include di-tert-butyl peroxide.

Other diesel fuel ignition improvers are disclosed in U.S. Pat. No. 4,208,190 at column 2, line 27 to column 3, line 21.

In particular, the ignition improver may be selected from (cyclo)alkyl nitrates such as 2-ethylhexyl nitrate (2-EHN), dialkyl peroxides such as di-tert-butyl peroxide, and mixtures thereof. It may in particular be a (cyclo)alkyl nitrate such as 2-EHN.

Diesel fuel ignition improvers are commercially available for instance as HITECT™ 4103 (ex. Afton Chemical) and as CI-0801 and CI-0806 (ex. Innospec Inc.).

Lubricity enhancing additives used in conventional fuel compositions may be any additive capable of improving the lubricity of a fuel composition and/or of imparting anti-wear effects when the composition is in use in an engine or other fuel-consuming system.

The lubricity enhancing additive may contain, typically as active constituent(s), one or more carboxylic acids. Suitable carboxylic acids include fatty acids and aromatic acids, in particular fatty acids such as those listed below. A lubricity enhancing additive may alternatively be based on non-acid actives such as esters or amides. Preferably the lubricity enhancing additive is ester- or amide-based, more preferably ester-based.

Suitable esters for use in such additives are carboxylic acid esters, in particular those derived from fatty acids, and mixtures thereof. Such fatty acids may be saturated or unsaturated (which includes polyunsaturated). They may for example contain from 1 or 2 to 30 carbon atoms, suitably from 10 to 22 carbon atoms, preferably from 12 to 22 or from 14 to 20 carbon atoms, more preferably from 16 to 18 carbon atoms and most preferably 18 carbon atoms. Examples include oleic acid, linoleic acid, linolenic acid, linolic acid, stearic acid, palmitic acid and myristic acid. Of these, oleic, linoleic and linolenic acids may be preferred, more preferably oleic and linoleic acids. In one embodiment of the present invention, the lubricity enhancing additive is a derivative (in particular an ester) of tall oil fatty acid, which is derived from tall oil and contains mostly fatty acids (such as oleic and linoleic) with a small proportion of rosin acids.

Lubricity enhancing additives based on ester-functionalised oligomers or polymers (e.g. olefin oligomers) may also be of use. Such esters may be mono-alcohol esters such as methyl esters, or more suitably may be polyol esters such as glycerol esters. Most preferred is a mono-, di- or tri-glyceride of a fatty acid, or conveniently a mixture of two or more such species.

Suitable amides for use in such additives are fatty acid amides, wherein preferred fatty acids may be as described above, for example fatty acid amides of mono- or in particular di-alkanolamines such as diethanolamine.

Suitable commercially available lubricity enhancing additives include the fatty acid-based R650 (ex. Infineum), the fatty acid ester-based R655 (ex. Infineum), the amide-based Hitec™ 4848A (ex. Afton) and the fatty acid-based Lz 539 series of products (ex. Lubrizol). Of these, fatty acid ester-based additives such as R655 may be preferred.

Other suitable lubricity enhancers are described for example in:

the paper by Danping Wei and H. A. Spikes, “The Lubricity of Diesel Fuels”, Wear, III (1986) 217-235;

WO-A-95/33805—cold flow improvers to enhance lubricity of low sulphur fuels;

WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;

U.S. Pat. No. 5,490,864—certain dithiophosphoric diester-dialcohols as anti-wear lubricity additives for low sulphur diesel fuels; and

WO-A-98/01516—certain alkyl aromatic compounds having at least one carboxyl group attached to their aromatic nuclei, to confer anti-wear lubricity effects particularly in low sulphur diesel fuels.

A lubricity enhancing additive may contain other ingredients in addition to the key lubricity enhancing active(s), for example a dehazer and/or an anti-rust agent, as well as conventional solvent(s) and/or excipient(s). Alternatively, a lubricity enhancing additive may consist essentially or even entirely of a lubricity enhancing active, or mixture thereof, of the type described above.

In the context of the above aspect of the present invention, the term “reducing” embraces any degree of reduction—for instance 5% or more of the original additive concentration, preferably 10 or 20% or more.

The reduction may be as compared to the concentration of the relevant additive which would otherwise have been incorporated into the formulation in order to achieve the properties and performance required or desired of it in the context of its intended use. This may for instance be the concentration of the additive which was present in the formulation prior to the realisation that a combination of a Fischer-Tropsch derived gas oil and an oxygenate could be used in the way provided by the present invention, or which was present in an otherwise analogous formulation intended (e.g. marketed) for use in an analogous context, prior to adding a combination of a Fischer-Tropsch derived gas oil and an oxygenate to it.

Thus, (active matter) concentration of the ignition improver in a fuel formulation prepared according to the present invention may be 3000 ppmw or less, preferably 1000 ppmw or less, for example from 5 to 50 ppmw. The formulation may contain no or substantially no ignition improving additives.

The (active matter) concentration of the lubricity enhancing additive used in a fuel composition according to the present invention may be 1000 ppmw or less, preferably 500 ppmw or less, more preferably 400 or 300 ppmw or less. Its (active matter) concentration will suitably be 100 ppmw or less, preferably 50 or 30 ppm or less. In the case of any lubricity enhancing additives, these may in fact be reduced to zero as a result of the use of the formulations of the first aspect of the present invention.

According to yet another aspect, the present invention provides a combination of a Fischer-Tropsch derived gas oil and oxygenate in an emulsified diesel fuel formulation, that improves the emissions performance of the formulation.

By “emissions performance” is meant the amount of combustion-related emissions (such as particulates, nitrogen oxides, carbon monoxides and gaseous (unburned) hydrocarbons and carbon dioxide) generated by a fuel consuming system (typically an engine such as a diesel engine) running on the relevant fuel formulation. In the context of the present invention, emissions of particulates and/or of nitrogen oxides NOx as well as black smoke, are of particular interest.

Thus, in general, an improvement in emissions performance may be manifested by a reduced level of combustion-related emissions when the fuel formulation is used in a fuel consuming system.

Emission levels may be measured using standard testing procedures such as the European R49, ESC, OICA or ETC for (for heavy-duty engines) or ECE+EUDC or MVEG (for light-duty engines) test cycles. Ideally emissions performance is measured on a diesel engine built to comply with the Euro II standard emissions limits (1996) or with the Euro III (2000), IV (2005) or even V (2008) standard limits. A heavy-duty engine is particularly suitable for this purpose. Gaseous and particle emissions may be determined using for instance a Horiba Mexa™ 9100 gas measurement system and an AVL Smart Sampler™ respectively.

In the context of the above aspect of the present invention, “improving” the emissions performance of the fuel formulation embraces any degree of improvement compared to the emissions performance of the formulation before the oxygenate is incorporated. This may, for example, involve adjusting the emissions performance of the formulation, by means of the oxygenate, in order to meet a desired target. For example, the precise amount of the oxygenate may be varied, or the precise chemical nature of the oxygenate may be varied in order to achieve the desired target.

In particular, as a result of the inclusion of Fischer-Tropsch derived gas oil in the formulation of the present invention, the cetane number of the formulation may be maintained.

The cetane number of a fuel formulation may be determined in known manner, for instance using the standard test procedure ASTM D613 (ISO 5165, IP 41) which provides a so-called “measured” cetane number obtained under engine running conditions.

More preferably, the cetane number may be determined using the more recent and precise “ignition quality test” (IQT) (ASTM D6890, IP 498), which provides a “derived” cetane number based on the time delay between injection and combustion of a fuel sample introduced into a constant volume combustion chamber. This relatively rapid technique can be used on laboratory scale (ca 100 ml) samples of a range of different fuels.

Alternatively, cetane number may be measured by near infrared spectroscopy (NIR), as for example described in U.S. Pat. No. 5,349,188. This method may be preferred in a refinery environment as it can be less cumbersome than for instance ASTM D613. NIR measurements make use of a correlation between the measured spectrum and the actual cetane number of a sample. An underlying model is prepared by correlating the known cetane numbers of a variety of fuel samples with their near infrared spectral data.

The present invention may result in a fuel formulation which has a derived cetane number (IP 498) of 40 or greater, or of 50 or greater, or of 60 or greater.

In the context of the present invention, use of a combination of a Fischer-Tropsch derived gas oil and an oxygenate in a fuel formulation means incorporating these elements into the formulation, typically as a blend (i.e. a physical mixture) with one or more other fuel components. The blend will conveniently be incorporated before the formulation is emulsified and introduced into an engine or other system which is to be run on the formulation. Instead or in addition the use of a combination of a Fischer-Tropsch derived gas oil and an oxygenate may involve running a fuel-consuming system, typically an engine such as a diesel engine, on an emulsified fuel formulation containing the component, typically by introducing the emulsified formulation into a combustion chamber of an engine.

The oxygenate or where present, the emulsifier, may itself be supplied as part of a mixture which is suitable for and/or intended for use as a fuel additive.

Components (a) to (c) may be blended together in accordance with the present invention described above, in particular with respect to the emission reducing properties of the resultant fuel formulation. An emulsifier is suitably also included in the formulation.

Components (a) to (c) may optionally be blended with one or more additional components, for example fuel additives of the type described above.

Another aspect of the present invention provides a method of operating a fuel consuming system, which method involves introducing into the system a fuel formulation according to the first aspect, and/or a fuel formulation prepared according to the second aspect. Again the fuel formulation may be introduced for one or more of the purposes described above in connection with the sixth or seventh aspects of the present invention, in particular to reduce combustion-related emissions from the system.

The fuel consuming system may in particular be an engine, such as an automotive engine, in which case the method may involve introducing the fuel formulation into a combustion chamber of the engine. It may be an internal combustion engine, and/or a vehicle which is driven by an internal combustion engine. The engine is preferably a compression ignition (diesel) engine. Such a diesel engine may be of the direct injection type, for example of the rotary pump, in-line pump, unit pump, electronic unit injector or common rail type, or of the indirect injection type. It may be a heavy or a light duty diesel engine.

Engines of this type may produce improved results in particular in relation to the reduction of combustion-related emissions if they further comprise an exhaust after-treatment device, such as a catalytic converter or diesel particulate filter. Such devices are suitably selected or set up so as to reduce emissions from the particular formulation of the present invention being used.

Thus, in another aspect, the present invention provides a vehicle emissions control system comprising an engine adapted to run on a formulation according to the first aspect, and an exhaust after-treatment device adapted to remove emissions obtained from combustion of said formulation in the engine.

Throughout the description and claims of this specification, the words “comprise” and “contain” and variations of the words, for example “comprising” and “comprises”, mean “including but not limited to”, and are not intended to (and do not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Preferred features of each aspect of the present invention may be as described in connection with any of the other aspects.

Other features of the present invention will become apparent from the following examples. Generally speaking the present invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the present invention are to be understood to be applicable to any other aspect, embodiment or example described herein unless incompatible therewith.

Moreover, unless stated otherwise, any feature disclosed herein may be replaced by an alternative feature serving the same or a similar purpose.

The following examples illustrate the preparation and properties of fuel formulations in accordance with the present invention.

### EXAMPLE 1

A series of emulsion blends were made from mixtures of water and GTL Fuel incorporating 5 or 10% of several different biocomponents that are typically used in the fuel market. GTL fuel was sourced from the Shell plant in Bintulu, Malaysia and had key physical properties as set out in Table 1 below. The POME and RME were obtained from commercial sources.

TABLE 1

| Fuel Property | Test method | Result |
|---|---|---|
| Cetane Number | ASTM D613 | 79 |
| Density @ 15° C.(g/cm³) | IP365/ASTM D4052 | 0.7846 |
| Kinematic viscosity @40° C. | IP71/ASTM D445 | 3.497 |
| (cSt) | | |
| Cloud Point (° C.) | IP219 | −0.5 |
| CFPP (° C.) | IP 309 | −1 |
| Distillation (° C.) | IP 123/ASTM D86 | |
| IBP | | 219.5 |
| 10% | | 245.9 |
| 20% | | 258.8 |
| 30% | | 270.1 |
| 40% | | 282.5 |
| 50% | | 295.2 |
| 60% | | 307.2 |
| 70% | | 317.7 |
| 80% | | 328.1 |
| 90% | | 342.1 |
| 95% | | 353 |
| FBP | | 358.2 |
| Flash Point ° C. | IP34 | 101 |

The emulsions were made using a two-component emulsifier formula by vigorous agitation of the fluids using a Silverson high shear mixer. De-ionised water was added dropwise over a period of one minute and the mixture was agitated for a further 1 minute to ensure complete mixing.

The resultant emulsions, details of which are shown in Table 2, were decanted into measuring cylinders and the degree of separation was monitored regularly over a period of one week. The results are shown in Table 3.

TABLE 2

| | F-T | | | | TWEEN | SPAN |
|---|---|---|---|---|---|---|
| | gas oil | POME | RME | Water | 21 | 80 |
| Sample | (% v/v) | (% v/v) | (% v/v) | (% v/v) | (% v/v) | (% v/v) |
| A | 85 | | | 13 | 1 | 1 |
| B | 80 | 5 | | 13 | 1 | 1 |
| C | 80 | | 5 | 13 | 1 | 1 |
| D | 74 | | | 20 | 3 | 3 |
| E | 69 | 5 | | 20 | 3 | 3 |
| F | 69 | | 5 | 20 | 3 | 3 |
| G | 75 | 10 | | 13 | 1 | 1 |
| H | 75 | | 10 | 13 | 1 | 1 |

TABLE 3

| | 1 | 3 | 30 | 2 | 1 | 2 | 3 | 4 | 1 |
|---|---|---|---|---|---|---|---|---|---|
| Sample | min | mins | mins | hours | day | days | days | days | week |
| A | S | S | S | S | S | S | S | S | S |
| B | S | S | S | S | S | S | SS | SS | NS |
| C | S | S | S | S | SS | SS | SS | SS | NS |
| D | S | S | S | S | S | S | SS | SS | SS |
| E | S | S | S | S | S | S | S | S | NS |
| F | S | S | S | S | S | S | S | S | NS |
| G | S | S | S | S | S | S | S | S | SS |
| H | S | S | S | S | SS | NS | NS | NS | NS |

where S indicates stable with no visible separation at all;
SS indicates some separation with some visible sediment or clearing of emulsion at the top; and
NS indicates not stable with complete phase separation.

The results show that formulations in accordance with the present invention may be stable for useful periods of time. In particular, it is apparent that it is possible to make emulsions that are stable for several days or more with the fatty acid methyl esters in the 20% water case and in other cases, the emulsions were stable for up to 2 days. 2 days is considered to be a reasonable criterion for emulsions to be useable in an automotive fuel.

We claim:

1. A diesel fuel formulation comprising a water-in-fuel emulsion of (a) a Fischer-Tropsch derived gas oil, (b) a fatty acid alkyl ester in an amount of at least 1% v/v and (c) water.

2. The diesel fuel formulation of claim 1 further comprising an emulsifier.

3. The diesel fuel formulation of claim 1 further comprising conventional diesel.

4. The diesel fuel of claim 1 where the water is present in an amount of 1% v/v or greater.

5. The diesel fuel of claim 4 further comprising an emulsifier.

6. The diesel fuel of claim 5 wherein the emulsifier is present in an amount of 0.1% v/v or greater.

7. A method for preparing a diesel fuel formulation comprising blending together, with agitation, the components comprising (a) a Fischer-Tropsch derived gas oil, (b) a fatty acid alkyl ester in an amount of at least 1% v/v and (c) water so as to form a water-in-fuel emulsion.

8. A kit for preparing a diesel fuel formulation comprising a combination of at least two members selected from the group consisting of (i) a Fischer-Tropsch derived gas oil, (ii) a fatty acid alkyl ester and (iii) an emulsifier.

9. The kit of claim 8 wherein two or more members of the combination are combined in a pre-mix and/or the kit is combined with an apparatus for forming an emulsion.

10. A method of operating a fuel consuming system, which method comprises introducing into the system a fuel formulation of claim 1.

11. A vehicle emissions control system comprising an engine adapted to run on a formulation of claim 1, and an exhaust after-treatment device adapted to remove emissions obtained from combustion of said formulation in the engine.
